(19) United States
(12) Patent Application Publication
(10) Pub. No.: US 2025/0317902 A1
(43) Pub. Date: Oct. 9, 2025

(54) WIRELESS COMMUNICATION METHOD AND DEVICE THEREOF

(71) Applicant: ZTE CORPORATION, Shenzhen (CN)

(72) Inventors: Youjun HU, Shenzhen (CN); Bo DAI, Shenzhen (CN); Mengzhu CHEN, Shenzhen (CN); Jun XU, Shenzhen (CN); Kun LIU, Shenzhen (CN); Weiwei YANG, Shenzhen (CN); Luanjian BIAN, Shenzhen (CN)

(73) Assignee: ZTE CORPORATION, Shenzhen (CN)

(21) Appl. No.: 19/222,291

(22) Filed: May 29, 2025

Related U.S. Application Data
(63) Continuation of application No. PCT/CN2023/075479, filed on Feb. 10, 2023.

(51) Int. Cl. H04W 68/02; H04W 56/00; H04W 72/0457; H04W 72/231

(52) U.S. Cl. CPC H04W 68/02; H04W 56/0015; H04W 72/0457; H04W 72/231

(57) ABSTRACT

A wireless communication method for use in a first communication node is disclosed. The method comprises receiving. from a second communication node, a first signal, and determining a process for a second signal based on the first signal.

### CROSS-REFERENCE TO RELATED PATENT APPLICATIONS

This application is a Continuation of US Application PCT/CN2023/075479, filed Feb. 10, 2023, incorporated herein by reference in its entirety.

### TECHNICAL FIELD

This document is directed generally to wireless communications, and in particular to 5G communications, 6G or future wireless communications.

### BACKGROUND

As its name suggests, a Low-power wake-up signal (LP-WUS) is used for power saving. The wake-up receiver receives/monitors/detects the LP-WUS and sends a message to a main radio to wake it up. As for UE (user equipment), the LP-WUS may be sent to the UE only when a paging from a gNB arrives at the UE and the UE may be woken up. Based on this, the UE can keep sleeping most of the time and does not need to frequently wake up for monitoring signals (e.g., RRM (radio resource management) measurement signals).

### SUMMARY

This document relates to methods, systems, and devices for saving power.

The present disclosure relates to a wireless communication method for use in a first communication node. The method comprises:
receiving, from a second communication node, a first signal, and
determining a process for a second signal based on the first signal

Various embodiments may preferably implement the following features:

Preferably or in some embodiments, the wireless communication method comprises performing the determined process for the second signal based on the first signal.

Preferably or in some embodiments, the first signal comprises at least one of at least one low power signal, a paging channel, a sequence, a reference signal, a downlink signal or a downlink channel.

Preferably or in some embodiments, a modulation of the low power signal is On-Off Keying, Amplitude Shift Keying or Frequency-Shift Keying.

Preferably or in some embodiments, the low power signal is configured with a periodicity and/or at least one transmission in a time duration.

Preferably or in some embodiments, the second signal comprises at least one of an SS/physical broadcast channel block (SSB), a system information block, a paging signal, a Primary Synchronization Sequence (PSS), a Secondary Synchronization Sequence (SSS), a physical random access channel, a message A (msgA), a channel state information reference signal, a physical downlink control channel, a paging channel, a physical uplink control channel, a tracking reference signal, a sequence or a preamble.

Preferably or in some embodiments, the first signal is configured for a first cell and the second signal is configured for a second cell.

Preferably or in some embodiments, the first signal is configured for a first carrier and the second signal is configured for a second carrier.

Preferably or in some embodiments, the first signal is configured for a first bandwidth part (BWP) and the second signal is configured for a second BWP.

Preferably or in some embodiments, the first signal is configured for a first area and the second signal is configured for a second area.

Preferably or in some embodiments, the first signal is configured for a first radio access technology (RAT) and the second signal is configured for a second RAT

Preferably or in some embodiments, a first frequency for the first signal is different from a second frequency for the second signal.

Preferably or in some embodiments, the first frequency for the first signal is lower than the second frequency for the second signal

Preferably or in some embodiments, the first frequency for the first signal is predefined or indicated by a signaling.

Preferably or in some embodiments, determining the process for the second signal based on the first signal comprises: determining the process for the second signal based on an indication carried by the first signal.

Preferably or in some embodiments, the indication comprises one or more bits, one or more preambles, one or more sequences, or one or more cyclic redundance check (CRC) bits.

Preferably or in some embodiments, determining the process for the second signal based on the first signal comprises: determining a reception of a third signal or a transmission of a fourth signal, wherein the third signal is a downlink signal and the fourth signal is an uplink signal.

Preferably or in some embodiments, an occasion of the fourth signal is associated with the first signal.

Preferably or in some embodiments, determining the process for the second signal based on the first signal comprises: determining the process for the second signal based on at least one parameter associated with the first signal.

Preferably or in some embodiments, determining the process for the second signal based on the first signal comprises: performing the process for the second signal if one of the at least one parameter is greater, smaller, not greater or not smaller than a threshold.

Preferably or in some embodiments, the threshold is configured by the second communication node, a signaling, or downlink control information or predefined.

Preferably or in some embodiments, performing the process for the second signal if the parameter is greater, smaller, not greater or not smaller than the threshold comprises:
performing the process for the second signal if the parameter is greater, smaller, not greater or not smaller than the threshold in a period, wherein the period is based on a timer, a signaling from the second communication node, a predefinition, or a downlink control information indication.

Preferably or in some embodiments, the at least one parameter comprises at least one of a reference signal received power, a reference signal received quality, a received signal strength indicator, a metric associated with a signal strength or a signal quality of the first signal, or a metric associated with a change in the signal strength or the signal quality of the first signal.

Preferably or in some embodiments, determining the process for the second signal based on the first signal comprises: determining the process for the second signal based on a predefined or a configured part of the first signal which is not received by the first communication node.

Preferably or in some embodiments, determining the process for the second signal based on the first signal comprises: determining the process for the second signal based on a predefined or a configured part of the first signal which is not present in the received first signal.

Preferably or in some embodiments, the predefined or the configured part comprises at least one of at least a field, a sequence, a preamble or the N bits in the first signal, where N is a positive integer.

Preferably or in some embodiments, determining the process for the second signal based on the first signal comprises: determining the process for the second signal based on the first signal and a fifth signal received from the second communication node.

Preferably or in some embodiments, the process is performed within or after a time offset, a gap or a duration after receiving the first signal.

Preferably or in some embodiments, receiving, from the second communication node, the first signal comprises: receiving, from the second communication node, the first signal in a first frequency in response to a paging.

Preferably or in some embodiments, receiving, from the second communication node, the first signal comprises: receiving, from the second communication node, the first signal in the first frequency in response to a paging and a low power signal, a sequence, a preamble or an SSB or an DL signal.

Preferably or in some embodiments, the first signal overlaps with the second signal in time domain and/or frequency domain.

Preferably or in some embodiments, the first signal and the second signal are continuous in time domain and/or frequency domain.

Preferably or in some embodiments, receiving, from the second communication node, the first signal comprises: receiving, from the second communication node, the first signal if at least one condition is met.

Preferably or in some embodiments, the at least one condition comprises at least one of:
at least one parameter associated with a low power signal, a reference signal, a sequence or a preamble stratifies at least one threshold condition,
a predefined/configured low power signal, reference signal, the sequence or the preamble is received,
a reference signal, a sequence or a preamble of a low power signal is received, or
an RRC configuration or a SIB configuration is received.

Preferably or in some embodiments, determining the process for the second signal based on the first signal comprises: determining not to receive a third signal comprised by the second signal if at least one condition is met.

Preferably or in some embodiments, the at least one condition comprises at least one of:
at least one parameter associated with the first signal stratifies at least one threshold condition,
the first signal is received,
the first communication node is in a connected state,
downlink control information for a connected mode is received,
an indication is received via the first signal, a system information block, a media access control control element or a radio resource control parameter.

The present disclosure relates to a wireless communication method for use in a second communication node. The method comprises:
transmitting, to a first communication node, a first signal, and
determining a process for a second signal based on the first signal.

Various embodiments may preferably implement the following features:

Preferably or in some embodiments, the wireless communication method comprises performing the determined process for the second signal based on the first signal.

Preferably or in some embodiments, the first signal comprises at least one of at least one low power signal, a paging channel, a sequence, a reference signal, a downlink signal or a downlink channel.

Preferably or in some embodiments, a modulation of the low power signal is On-Off Keying, Amplitude Shift Keying or Frequency-Shift Keying.

Preferably or in some embodiments, the low power signal is configured with a periodicity and/or at least one transmission in a time duration.

Preferably or in some embodiments, the second signal comprises at least one of an SS/physical broadcast channel block (SSB), a system information block, a paging signal, a Primary Synchronization Sequence (PSS), a Secondary Synchronization Sequence (SSS), a physical random access channel, a message A (msgA), a channel state information reference signal, a physical downlink control channel, a paging channel, a physical uplink control channel, a tracking reference signal, a sequence or a preamble.

Preferably or in some embodiments, the first signal is configured for a first cell and the second signal is configured for a second cell.

Preferably or in some embodiments, the first signal is configured for a first carrier and the second signal is configured for a second carrier.

Preferably or in some embodiments, the first signal is configured for a first bandwidth part (BWP) and the second signal is configured for a second BWP.

Preferably or in some embodiments, the first signal is configured for a first area and the second signal is configured for a second area.

Preferably or in some embodiments, the first signal is configured for a first radio access technology (RAT) and the second signal is configured for a second RAT

Preferably or in some embodiments, a first frequency for the first signal is different from a second frequency for the second signal.

Preferably or in some embodiments, the first frequency for the first signal is lower than the second frequency for the second signal

Preferably or in some embodiments, the first frequency for the first signal is predefined or indicated by a signaling.

Preferably or in some embodiments, the first signal carries an indication of the process.

Preferably or in some embodiments, the indication comprises one or more bits, one or more preambles, one or more sequences, or one or more cyclic redundance check (CRC) bits.

Preferably or in some embodiments, determining the process for the second signal based on the first signal comprises: determining a transmission of a third signal or a reception of a fourth signal, wherein the third signal is a downlink signal and the fourth signal is an uplink signal.

Preferably or in some embodiments, an occasion of the fourth signal is associated with the first signal.

Preferably or in some embodiments, determining the process for the second signal based on the first signal comprises: determining the process for the second signal based on the first signal and a fifth signal transmitted to the first communication node.

Preferably or in some embodiments, the process is performed within or after a time offset, a gap or a duration after transmitting the first signal.

Preferably or in some embodiments, transmitting, to the first communication node, the first signal comprises: transmitting, to the first communication node, the first signal in a first frequency in response to a paging.

Preferably or in some embodiments, transmitting, to the first communication node, the first signal comprises:

Preferably or in some embodiments, transmitting, to the first communication node, the first signal in the first frequency in response to a paging and a low power signal, a sequence, a preamble, an SSB or a downlink signal.

Preferably or in some embodiments, the first signal overlaps with the second signal in time domain and/or frequency domain.

Preferably or in some embodiments, the first signal and the second signal are continuous in time domain and/or frequency domain.

Preferably or in some embodiments, transmitting, to the first communication node, the first signal comprises: transmitting, to the first communication node, the first signal if at least one condition is met.

Preferably or in some embodiments, the at least one condition comprises at least one of:
at least one parameter associated with a low power signal, a reference signal, a sequence or a preamble stratifies at least one threshold condition,
a predefined/configured low power signal, reference signal, the sequence or the preamble is transmitted,
a reference signal, a sequence or a preamble of a low power signal is transmitted, or
an RRC configuration or a SIB configuration is received.

Preferably or in some embodiments, determining the process for the second signal based on the first signal comprises: determining not to transmit a third signal comprised by the second signal if at least one condition is met.

Preferably or in some embodiments, the at least one condition comprises at least one of:
the first signal is transmitted,
the first communication node is in a connected state,
downlink control information for a connected mode is transmitted,
an indication is transmitted via the first signal, a system information block, a media access control control element or a radio resource control parameter.

The present disclosure relates to a first communication node. The first communication node comprises:
a communication unit, configured to receive, from a second communication node, a first signal, and
a processor, configured to determine a process for a second signal based on the first signal.

Various embodiments may preferably implement the following feature:

Preferably or in some embodiments, the processor is further configured to perform any of aforementioned wireless communication methods.

The present disclosure relates to a second communication node. The second communication node comprises:
a communication unit, configured to transmit, to a first communication node, a first signal, and
a processor, configured to determine a process for a second signal based on the first signal.

Various embodiments may preferably implement the following feature:

Preferably or in some embodiments, the processor is further configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows an example of a schematic diagram of a wireless terminal according to an embodiment of the present disclosure.

FIG. 3 shows an example of a schematic diagram of a wireless network node according to an embodiment of the present disclosure.

FIG. 4 shows a flowchart of a method according to an embodiment of the present disclosure.

FIG. 5 shows a flowchart of a method according to an embodiment of the present disclosure.

### DETAILED DESCRIPTION

In the present disclosure, “based on” may be used synonymously to “according to”.

It is common understanding that the signal has larger performance degradation and worse coverage performance in a high frequency range and has better coverage performance in a low frequency range.

Because of different designs for the LP-WUS and SSB (Synchronization Signal/Physical Broadcast Channel block), the LP-WUS and the SSB may have a large performance difference at the same frequency. To achieve comparable performance, the LP-WUS may need repetitions or other methods for acquiring better coverage performance. Under such conditions, however, the NW (network) resource overhead would be large and the UE also needs to spend more time on detecting the LP-WUS. In order to provide sufficient coverage performance and to save NW resource wasting and UE power, the present disclosure provides a novel method, i.e., transmitting the LP-WUS in a low frequency. Additionally, by combing the LP-WUS and the SSB and/or other signals at the same time, the RRM measurement performance may be improved.

Specifically, in some embodiments, the UE receives a first signal and determines (and performs) a process/operation/action for a second signal based on the first signal.

In an embodiment, the second signal includes a third signal and/or a fourth signal. For example, the third signal is/comprises DL (downlink) signal(s) or channel(s) and the fourth signal is/comprises UL (uplink) signal(s) or channel(s).

In an embodiment, the UE receiving the first signal may represent that the UE monitors and/or detects and/or decodes the first signal.

In an embodiment, the first/second/third/fourth signal includes (physical) signals or (physical) channels.

In an embodiment, the first signal comprises at least one of at least one low power signal, a paging channel, a sequence, a reference signal, a downlink signal or a downlink channel.

In an embodiment, the low power signal is configured with a periodicity and/or at least one transmission in a time duration.

For example, the lower power signal has a same periodicity with the SSB.

For example, the lower power signal is configured with a times relationship periodicity with the SSB, e.g., the periodicity of the low power signal is n*(SSB periodicity), where n is a coefficient which is less than, larger than or equal to 1.

For example, the lower power signal is configured with a periodicity with at least one of {10, 20, 40, 80, 160, 240, 320, 480, 640, 1280, 2560} time units, where the time units could be symbols, slots, ms, us and also on.

For example, the lower power signal is configured with at least one transmission in a time duration. In an embodiment the time duration could be {10, 20, 40, 80, 160, 240, 320, 480, 640, 1280, 2560} time units. As an alternative, the time duration is defined based a timer.

In an embodiment, the low power signal may comprise a LP-SS and/or a LP-WUS, wherein the LP-SS is used for synchronization or measurement and the LP-WUS is used for wake-up (e.g., the UE).

In an embodiment, the first signal includes at least one of the LP-WUS, a LP-SS (low-power synchronization signal) a paging (e.g., PDCCH or PDSCH or occasion), a sequence or a preamble. That is the first signal may be implemented by the LP-WUS, a LP-SS a paging PDCCH, a paging PDSCH, a paging occasion, a sequence or a preamble.

In an embodiment, a paging channel comprise a paging PDCCH, a paging PDSCH, or a paging occasion.

In an embodiment, the UE receives a paging channel means that the UE receives a paging PDCCH channel, a paging PDSCH channel, or a paging occasion.

In an embodiment, the first signal comprises the PSS or the SSS or a PSS based sequence or an SSS based sequence. For example, the PSS based sequence is obtained via a different initialized scrambling sequence generator. In addition, the SSS based sequence may be obtained via a different initialized scrambling sequence generator.

In an embodiment, the second signal includes at least one of the SSB, a SIB (system information block), CORESET#0, an initial DL BWP, a paging, a PSS (primary synchronization sequence), an SSS (secondary synchronization sequence), PRACH (physical random access channel), msgA (in two step random access procedure), a CSI-RS (channel state information reference signal), a PDCCH, a PUCCH, a paging channel, a TRS (tracking reference signal), a sequence or a preamble.

In an embodiment, the process includes at least one of reception, detection, monitor, decoding, transmission, report, feedback, send, trigger, or activation. Note that, none-operation also belongs to one kind of process/operation. That is, based on the first signal, the UE may receive, detect, monitor, decode, transmit, report, feedback, send, trigger and/or activate the second signal. As an alternative, the UE may determine not to perform any process/operation for the second signal.

In an embodiment, the UE receives/monitors/detects the first signal and determines, based on the first signal, (whether/how) to receive, detect, monitor and/or decode the third signal.

In an embodiment, the UE receives/monitors/detects/decodes the first signal and determines, based on the first signal, (whether/how) to transmit, report, feedback, send, trigger and/or activate the fourth signal.

In some embodiments, the BS (e.g., gNB or cell) transmits/sends/configures the first signal and performs a process/operation for the second signal, wherein the process/operation is determined based on the first signal. For example, based on the first signal, the second signal may be received, detected, monitored, decoded, transmitted, reported, fed back, sent, triggered, and/or activated. That is, based on the first signal, the BS may receive, detect, monitor, decode, receive the report, receive the feedback, transmit and/or send the second signal (from or to the UE).

In some embodiments, the first signal is configured for a first cell and the second signal is configured for a second cell. The first cell and second cell may be a PCell (Primary Cell), SCell (Secondary Cell), a SpCell (Special Cell) or a PsCell (Primary Secondary Cell).

In some embodiments, the first signal is configured for a first carrier and the second signal is configured for a second carrier. The first carrier and the second carrier may be CA (carrier aggregation) carriers.

In some embodiments, the first signal is configured for a first BWP (bandwidth part) and the second signal is configured for a second BWP. The first BWP and the second BWP may be an initial BWP or a dedicated BWP.

In some embodiments, the first signal is configured for a first area and the second signal is configured for a second area, wherein the first/second area is a tracking area or a RAN (radio access network (node)) area.

In some embodiments, the first signal is configured for a first RAN (radio access technology) and the second signal is configured for a second RAT.

In some embodiments, a first frequency for the first signal is lower than a second frequency for the second signal.

In some embodiments, the first frequency for the first signal is different from the second frequency for the second signal.

In an embodiment, the first frequency for the first signal is predefined or indicated by a signaling. In this embodiment, the first frequency may be configured to be the same or different from the second frequency of the second signal. Note that the signaling may include a high layer signaling (e.g. RRC signaling), a MAC CE (media access control control element) or a system information block (SIB).

In an embodiment, the first/second frequency means/refers to a frequency location.

In an embodiment, the first/second frequency refers to one of a frequency point, a center frequency (point), a (frequency) band, a carrier, a frequency range, a BWP (bandwidth part), a frequency resource and so on.

In an embodiment, the first signal is in first bands and the second signal is in second bands, where the frequency of the first bands is lower than or different from that of the second bands.

In an embodiment, the first and second frequency is in the FR1, and the first frequency is lower than or different from the second frequency.

In an embodiment, the first and second frequency is in the FR2, and the first frequency is lower than or different from the second frequency.

In an embodiment, the first frequency is in the FR1 and the second frequency is in the FR2.

In an embodiment, the first frequency is in the FR1 and the second frequency is in an unlicensed spectrum.

In an embodiment, the first frequency is in the unlicensed spectrum and the second frequency is in the FR2.

In an embodiment, the first frequency is in the unlicensed spectrum and the second frequency is in the FR1.

In an embodiment, the frequency or center frequency of the first signal is lower than or different from the second frequency for the second signal.

In an embodiment, the FR1 refers to frequency range 1 for NR (new radio) and FR2 means frequency range 2 for NR.

In an embodiment, the BWP of the first signal is lower than or different from that of the second signal.

In an embodiment, a first carrier for the first signal and a second carrier for the second signal are CA (carrier aggregation) carriers.

In an embodiment, the first/second carrier containing/comprising the first frequency is a low-power paging/wake-up carrier/carrier configured with paging.

In an embodiment, the cell supporting the first signal on the first frequency is a low-power/wake-up cell/cell configured with paging.

In an embodiment, the first signal has a lower frequency and the second signal has a higher frequency.

In an embodiment, the first signal is transmitted by Scell (secondary cell) and the second signal is transmitted by Pcell (primary cell) or the UE in the Pcell.

In an embodiment, a first cell transmitting the first signal and a second cell transmitting the second signal are co-located.

In an embodiment, the modulation (schemes) for the first signal is OOK/ASK/FSK (On-Off Keying/Amplitude Shift Keying/Frequency-Shift Keying).

In an embodiment, the modulation (schemes) for the first signal is OFDM or OFDM based signal, e.g., DFT-S-OFDM or other OFDM based signals.

In an embodiment, the first signal is (mainly) used for the LP-WUS wake-up/paging and the second signal is (mainly) used for main radio turning on and related procedure(s).

### UE Behaviors in Different Frequency

In some embodiments, the UE receives the first signal and determines (and performs) the process/operation/action determined based on the first signal for the second signal.

In these embodiments, the first frequency for the first signal is different with or lower than the second frequency for the second signal.

In some embodiments, the process is determined based on an indication associated with the first signal. The indication may be implicitly or explicitly carried via/by the first signal.

In an embodiment, the explicit indication comprises overhead/information bit(s) carried by the first signal. For example, the indication may comprise one or more bits, one or more preambles, one or more sequences, or one or more cyclic redundance check (CRC) bits carried by or attached to the first signal.

In an embodiment, the implicit indication comprises information bit(s) and/or other existing information derived based on (e.g., the reception of) the first signal.

In an embodiment, the first signal implicitly or explicitly indicates whether to process the second signal/whether to receive the second signal/whether to transmit the second signal.

In an embodiment, the LP-WUS implicitly or explicitly indicates whether to transmit/send the fourth signal (e.g., PRACH).

In an embodiment, the LP-WUS implicitly or explicitly indicates whether to receiver/monitor/decode the third signal (e.g., SSB/paging (PDCCH, PDSCH, or occasion)).

In an embodiment, the paging PDCCH or PDSCH implicitly or explicitly indicates whether to receive/monitor/decode the third signal (e.g., SSB).

In an embodiment, the paging PDCCH or PDSCH implicitly or explicitly indicates whether to transmit the fourth signal (e.g., PRACH/msgA).

In an embodiment, the process is determined based on a (metric) parameter for the first signal. For example, the (metric) parameter comprises at least one of a correlation value, RSRP, RSRQ, RSSI, or any other metric or any (metric) parameter reflecting the Signal Strength or quality.

In an embodiment, according to the metric or parameter for the first signal, if the metric or the parameter is worse/larger/lower/smaller than a (threshold) value, the UE would or would not process the second signal.

In an embodiment, according to a correlation value for the first signal, if the correlation value is lower than a (threshold) value, the UE may not receive the SSB/paging or transmit the PRACH.

In an embodiment, according to a correlation value for the first signal, if the correlation value is larger than a (threshold) value, the UE may receive the SSB/paging or transmit the PRACH.

In an embodiment, a correlation value is a parameter defined based on a correlation operation. For example, the correlation operation is based on Autocorrelation, cross-correlation or any defined formula.

In an embodiment, according to the RSRP, RSRQ, or RSSI value or correlation value for the first signal, if the RSRP, RSRQ, or RSSI value or the correlation value is lower than a (threshold) value, the UE may not receive the third signal (e.g., SSB/paging) or transmit the fourth signal (e.g., PRACH).

In an embodiment, according to the RSRP, RSRQ, or RSSI value or correlation value for the first signal, if the RSRP, RSRQ, or RSSI value or the correlation value for the first signal is larger than a (threshold) value, the UE may receive the third signal (e.g., SSB/paging) or transmit the fourth signal (e.g., PRACH).

In an embodiment, according to the difference value of correlation value, RSRP, RSRQ, or RSSI, if the correlation value, RSRP, RSRQ, or RSSI difference value is worse/lower/smaller than a (threshold) value, the UE may receive the third signal, e.g., SSB/paging or transmit the fourth signal (e.g., PRACH).

In an embodiment, according to the difference value of the correlation, RSRP, RSRQ, or RSSI, if the difference value of the correlation value, RSRP, RSRQ, or RSSI is larger than a (threshold) value, the UE may receive the third signal (e.g., SSB/paging) or transmit the fourth signal (e.g., PRACH).

In an embodiment, according to a defined metric parameter value, if the defined metric parameter value is worse/larger/lower/smaller than a (threshold) value, the UE may or may not process the second signal. For instance, this defined metric parameter value could be based on a correlation operation of the metric(s)/parameter(s) for the first signal.

In an embodiment, the threshold value(s) is configured by the gNB or predefined.

In an embodiment, the process is determined based on a (metric) parameter for the first signal, wherein the parameter includes a difference/variance value. The difference/variance value could be based on the correlation value, RSRP, RSRQ, RSSI, or any (metric) parameter reflecting the Signal Strength or quality change. For example, the difference/variance value may be a variance of the correlation value in a certain period, a variance of the RSRP/RSRQ/RSSI in a certain period, or a variance of the parameter reflecting the Signal Strength or quality change in a certain period.

In an embodiment, according to the difference value for the first signal, if the difference value is worse/larger/lower/smaller than a (threshold) value, the UE may or may not process the second signal.

For example, according to the difference value of the correlation value, RSRP, RSRQ, or RSSI, if the difference value is worse/lower/smaller than a (threshold) value, the UE may receive the paging or the UE may transmit PRACH/msgA

For example, according to the difference value of the correlation value, RSRP, RSRQ, or RSSI, if the difference value is larger than a (threshold) value, the UE may receive the SSB.

In an embodiment, the process may be determined based on whether the UE receives the first signal.

For example, if the UE does not receive the first signal, the UE needs to process the second signal (e.g., receive the SSB, the CSI-RS and/or the TRS).

As an alternative or in addition, if the UE does not receive the first signal, the UE does not need to process the second signal (e.g., transmit the PRACH).

As an alternative or in addition, if the UE does not receiver the first signal, the UE does not need to process the second signal (e.g., transmit the PRACH) in a time duration.

In an embodiment, the process is determined based on whether the UE receives the first signal and/or whether the signal (metric) parameter for the first signal is larger/lower than a threshold value in a time duration.

In an embodiment, the time duration is based on a timer, a configuration from the gNB, a predefinition or an indication carried by DCI (downlink control information).

For example, if the correlation value/RSRP/RSRQ/RSSI/defined parameter for the first signal is lower than a threshold value in the time duration, and/or if the UE does not receive the first signal in the time duration, the UE needs to process the second signal (e.g., receive the SSB, the CSI-RS and/or the TRS.

As an alternative or in addition, if the correlation value/RSRP/RSRQ/RSSI/defined parameter for the first signal is larger than a threshold value, the UE needs to process the second signal, e.g., transmit the PRACH/msgA.

As an alternative or in addition, if the difference value of correlation/RSRP/RSRQ/RSSI/defined parameter for the first signal is larger than a threshold value, and/or if the UE does not receive the first signal, the UE needs to process the second signal e.g., receive the SSB, the CSI-RS and/or the TRS.

As an alternative or in addition, if the difference value of correlation/RSRP/RSRQ/RSSI/defined parameter for the first signal is less than a threshold value, the UE needs to process the second signal e.g., receive the SSB, the CSI-RS, the TRS, the paging or transmit the PRACH/msgA.

In an embodiment, the process is determined based on a predefined or a configured part of the first signal. For example, the process is determined based on whether the predefined/configured part of the first signal is decoded/detected or not.

In an embodiment, the predefined/configured part of the first signal may be certain defined overhead/bits (e.g., CRC bits, a field, or at least a sequence, at least a preamble, or (the first) N bits of the first signal (N is a positive integer)).

For example, if a CRC verification for the first signal is failed, the UE needs to process the second signal e.g., receive the SSB, the CSI-RS and/or the TRS.

As an alternative or in addition, if a field indicating a state is not decoded/detected/received, or a field indicating a state is decoded/detected/received, the UE needs to process the second signal, e.g., receive SSB,CSI-RS,TRS and/or transmit PRACH/msgA, receiver paging.

As an alternative or in addition, if a sequence or a preamble is not decoded/detected/received, the UE needs to process the second signal, e.g., receive the SSB, the CSI-RS and/or the TRS.

As an alternative or in addition, if a sequence or preamble is decoded/detected/received, the UE needs to process the second signal, e.g., transmit the PRACH/msgA.

In an embodiment, the sequence or the preamble has the same modulation scheme with the first signal.

In an embodiment, the sequence or preamble and the first signal are continuous/contiguous in the time domain.

In an embodiment, the UE receives the first signal and performs the process for the second signal, wherein the process is determined based on the first signal and further based on a sequence, a preamble or a reference signal.

In an embodiment, the determination of the process based on the first signal may be based on at least one of the above discussed cases, i.e., based on at least one of the indication carried via the first signal, the (metric) parameter for the first signal, the missing part of the first signal or whether the first signal is received.

In an embodiment, the process is determined further based on a sequence, a preamble or a reference signal. For example, the process is determined based on carried information and/or the detection/decoding/reception of the sequence, the preamble or the reference signal.

In an embodiment, the UE receives a (low power) synchronization reference signal and receives the first signal indicating the main radio wake-up. In this embodiment, the UE needs to process the second signal, e.g., receive the third signal and/or transmit the fourth signal.

In an embodiment, the (low power) synchronization reference signal may be decoded/detected/received by all the UEs supporting a corresponding function/feature.

In an embodiment, the UE receives the sequence or the preamble, and receives the first signal indicating the main radio wake-up. Under such conditions, the UE needs to process the second signal, e.g., receive the third signal and/or transmit the fourth signal.

In an embodiment, the sequence or the preamble can be decoded/detected/received by a group of UEs, multiple UEs, or at least one UE.

In an embodiment, the sequence or preamble can be decoded/detected/received by specific UE(s). For example, the UE receives a paging message specific for this UE and receives the first signal with satisfied (metric) parameter. In this case, the UE needs to process the second signal, e.g., receive the third signal and/or transmit the fourth signal.

In an embodiment, the UE receives the first signal and determines the process determined based on the first signal for the second signal. The first frequency for the first signal may be lower than the second frequency for the second signal or the first frequency for the first signal may be different from the second frequency for the second signal. In this embodiment, a time duration/delay is defined for the period after the UE receiving the first signal. The UE may perform the process within or after the defined period.

That is, if the UE receives the first signal and the UE needs to process the second signal, the UE may process the second signal within or after a time duration/delay after the reception of the first signal.

For example, if UE receives the first signal, the UE (can/need to) perform the process for the second signal at least after the time duration/delay.

In an embodiment, X time units after the UE receives the LP-WSU/LP-SS, the UE (can/need to) receive the third signal (e.g., SSB and/or paging).

In an embodiment, X time units after the UE receives the LP-WSU/LP-SS, the UE (can/need to) transmit the fourth signal (e.g., PRACH/msgA).

In an embodiment, X is a positive integer and the time unit for the duration/delay may be a symbol, a slot, a subframe, a basic time unit for NR Tc, or a basic time unit for WUR (WUR is used for receiving LP-WUS/LP-SS).

In an embodiment, the UE receives the first signal and determines the process for the second signal processing based on the first signal. In this embodiment, the first frequency for the first signal is lower than the second frequency for the second signal or the first frequency for the first signal is different from the second frequency for the second signal. For example, a paging is configured in the first frequency and the UE receives the paging in the first frequency. Based on the paging (i.e., the first signal), the UE determines (and performs) the process for the second signal in the second frequency.

In an embodiment, the UE receives the paging, paging PDCCH or paging PDSCH in the first frequency. Based on the (implicit or explicit) indication carried by the paging or via paging PDCCH or PDSCH, the UE needs to process the second signal, e.g., receive the third signal (e.g., SSB) in the second frequency.

In an embodiment, the UE receives the paging in the first frequency. Based on the indication by paging via paging PDCCH or PDSCH implicitly or explicitly, the UE needs to process the second signal, e.g., transmit the fourth signal (e.g., PRACH/msgA) in the second frequency.

In an embodiment, the UE receives the LP-SS/LP-WUS/sequence/preamble/SSB and the paging in the first frequency. Based on the indication by paging via paging PDCCH or PDSCH implicitly or explicitly, and/or based on the detection/decoding/reception of the LP-SS/LP-WUS/sequence/preamble/SSB, the UE needs to process the second signal, e.g., transmit the fourth signal (e.g., the PRACH/msgA) in the second frequency.

In an embodiment, the detection/decoding/reception of the LP-SS/LP-WUS/sequence/preamble/SSB is determined based on whether the (metric) parameter(s) of the LP-SS/LP-WUS/sequence/preamble/SSB satisfies certain conditions (e.g., greater/smaller than a corresponding threshold value) or whether LP-SS/LP-WUS/sequence/preamble/SSB is detected/decoded/received.

In an embodiment, the UE receives the LP-SS/LP-WUS/sequence/preamble and the paging in the first frequency. Based on the indication by paging via paging PDCCH or PDSCH implicitly or explicitly, and/or according to the detection/decoding/reception of the LP-SS/LP-WUS/sequence/preamble, the UE needs to process the second signal, e.g., receive the third signal (e.g., SSB) and/or transmit the fourth signal (e.g., PRACH/masgA) in the second frequency.

In an embodiment, the paging search space is configured in the first frequency by SIB1/SIB.

In an embodiment, the UE receives the first signal and determines (whether to perform) the process for the second signal based on the first signal. In this embodiment, first resources for the first signal overlap with second resources for the second signal in the time domain and/or the frequency domain.

As an alternative or in addition, the first resources for the first signal and the second resources for the second signal is continuous/contiguous in the time domain and/or the frequency domain.

As an alternative or in addition, the first resources for the first signal overlap with the second resources for the second signal in the time domain.

In an embodiment, the LP-WUS/LP-SS resources overlap with the SSB in the time domain.

In an embodiment, the LP-WUS/LP-SS resources have the same occupied symbol as the SSB resources in the time domain.

In an embodiment, the first resources for the first signal and the second resources for the second signal are continuous/contiguous in the time domain.

For example, the LP-WUS/LP-SS resources and the SSB are continuous in the time domain.

As an alternative or in addition, the LP-WUS/LP-SS resources and SSB have continuous/contiguous symbols in the time domain.

In an embodiment, the first resources for the first signal have an offset/gap with the second resources for the second signal in the time domain.

For example, the LP-WUS/LP-SS resources have an offset/gap with the SSB in the time domain. The offset/gap may be X ms (millisecond), us (microsecond), symbols, slots, subframes, frames, any other time units including basic time unit for NR Tc, or basic time units for the WUR.

In an embodiment, the first resources for the first signal overlap with the second resources for the second signal in the frequency domain.

For example, the LP-WUS/LP-SS resources overlap with the SSB in the frequency domain.

As an alternative or in addition, the LP-WUS/LP-SS resources have the same occupied frequency resource(s) (e.g., RE(s) or RB(s)) as the SSB in the frequency domain.

In an embodiment, the first resources for the first signal and the second resources for the second signal are continuous/contiguous in the frequency domain.

For example, the LP-WUS/LP-SS resources and the SSB are continuous/contiguous in the frequency domain.

For instance, the LP-WUS/LP-SS resources and the SSB have continuous/contiguous frequency resources (e.g., RB number) in the frequency domain.

In an embodiment, the first resources for the first signal and the second resources for the second signal have the same pattern/periodicity. The pattern may be equated to a periodicity and an offset.

In an embodiment, the first periodicity for the first resources of the first signal and the second periodicity for the second resources of the second signal have multiple relations.

For example, the position in the time domain for the first signal may be a subset of all the positions for the second signal in the time domain, and vice versa.

In an embodiment, a first bandwidth of the first signal is no larger than a second bandwidth of the second signal.

In an embodiment, the first bandwidth and a guard-band of the first signal is not larger than those of the second signal.

For example, the bandwidth of the LP-WUS/LP-SS resources and their guard-band resources are no larger than those of the SSB.

In an embodiment, the bandwidth and the guard-band of the first signal are larger than those of the second signal.

In an embodiment, the UE receives the first signal and determines (and performs) the process for the second signal based on the first signal. In this embodiment, the UE receives/monitors/detects/decodes the first signal and determines (whether/how) to transmit, report, feedback, send, trigger or activate the fourth signal.

In an embodiment, the fourth signal (e.g., PRACH/msgA) is aperiodic.

In an embodiment, an occasion of the fourth signal is associated with the first signal. In other words, the first signal is associated with or mapped to the occasion of the fourth signal.

For example, the PRACH occasion is associated with the LP-WUS/LP-SS. That is, the LP-WUS/LP-SS (resources) are mapped to or associated with the PRACH occasion.

For example, the PRACH occasion is associated with the SSB or the PSS/SSS or the PSS/SSS based signal.

In an embodiment, the first signal and the third signal are associated with or mapped to the occasion of the fourth signal.

For example, the LP-WUS/LP-SS and the SSB are associated with or mapped to the PRACH occasion.

In an embodiment, the UE receives the first signal with certain conditions.

In an embodiment, the conditions comprise receiving a corresponding indication, which includes an RRC indication, a DCI indication, a SIB (e.g., SIB1) indication, Mac indication. Note that the term ‘indication’ may be replaced by ‘configuration’.

In an embodiment, the indication may be a feature/parameter configured via the RRC/SIB/Mac CE. That is the UE receives the first signal if/when a feature/parameter is configured via the RRC/SIB/Mac CE.

In an embodiment, the indication is associated with a time period/duration or a timer configured via the RRC/SIB/Mac CE. For example, the UE may receive the first signal if/when a time period/duration or a timer is configured via RRC/SIB/Mac CE.

In an embodiment, the conditions comprise that the (metric) parameter(s) for the LP-SS/reference signal/sequence/preamble satisfies some conditions (e.g., the (metric) parameter(s) is lower or larger when compared with corresponding threshold value(s).

In an embodiment, the conditions comprise whether the LP-SS/reference signal/sequence/preamble is received/detected/decoded.

In an embodiment, if the (metric) parameter for LP-SS/reference signal/sequence/preamble is less or larger than a threshold value, the UE receives/monitors/detects the first signal.

For example, if the signal strength (e.g., RSRP) of the LP-SS is larger than a threshold value, the UE receives/monitors/detects the LP-WUS/paging.

As an alternative or in addition, if the signal strength difference value of the LP-SS is less than a threshold value, the UE receives/monitors/detects the LP-WUS/paging.

As an alternative or in addition, if the LP-SS/reference signal/sequence/preamble is received/detected/decoded, the UE receives/monitors/detects the first signal.

As an alternative or in addition, if certain RRC signaling or SIB signaling is received/detected/decoded, the UE receives/monitors/detects the first signal.

In some embodiments, the UE may not receive the first signal under certain conditions.

In embodiment, if/when the UE receives from the gNB an indication of not receiving the first signal, the UE does not (need to) receive the first signal.

For example, the gNB indicates that the first signal (e.g., LP-WUS/LP-SS) is not valid/configured in a connected mode.

As an alternative or in addition, the signaling received via the gNB may indicates the UE not to receive/detect/monitor/decode the first signal (e.g., LP-WUS/LP-SS).

For example, the gNB indicates that the UE does not need to receive/detect/monitor/decode the first signal (e.g., LP-WUS/LP-SS) in a time duration/in a period.

In an embodiment, if/when the UE receives a signal from the gNB, the UE does not receive the first signal.

For example, the signal may be msg4 (in random access procedure). When the UE receives the msg4 (successfully) from the gNB, the UE does not receive the first signal, e.g., LP-WUS/LP-SS.

As an alternative, the signal is the third signal (e.g., Paging/SSB).

In an embodiment, if/when the UE sends a signal, the UE does not receive the first signal.

For example, after the UE sends msg5, after UE is in connected mode, after the UE reports its capability, after the UE sends the PRACH/msgA and/or after the UE feedbacks ACK/NACK, the UE does not receive the first signal (e.g., LP-WUS/LP-SS) or whether to receive the first signal is up to the UE (implementation).

In an embodiment, the UE receives the first signal and does not (need to) receive the third signal with some conditions. The conditions comprise:
If the (metric) parameter for the LP-SS/reference signal/sequence/preamble is less or larger than a threshold value, the UE does not receive the third signal (e.g., SSB).
If the LP-WUS/LP-SS/reference signal/sequence/preamble is detected/monitored/received/configured/decoded, the UE does not receive the third signal (e.g., SSB).
if being in connected mode: For example, the UE in the (RRC) connected mode receives the first signal and does not (need to) receive the third signal.
gNB indication/signaling: For example, the UE receives the first signal and does not (need to) detect/monitor/receive/decode the third signal (e.g., SSB) according to the gNB indication/signaling (e.g., RRC signaling, DCI signaling, SIB signaling, or Mac signaling. The signaling may be the activation signaling/deactivation signaling.
A time duration: For instance, the UE receives the first signal and does not (need to) receive/detect/monitor/decode the third signal (e.g., SSB) in a time duration.
A timer: For example, the UE receives the first signal and does not (need to) receive/detect/monitor/decode the third signal (e.g., SSB) according to the timer, e.g., before the timer expires.

In the present disclosure, the LP-WUS refers to low power wake up signal. The LP-SS refers to low power sync signal.

In an embodiment, the LP-WUS and LP-SS use the same modulation (e.g., OOK, ASK, FSK).

In an embodiment, the LP-SS has the function of synchronization or measurement.

In an embodiment, the LP-WUS has the function of wake-up main radio.

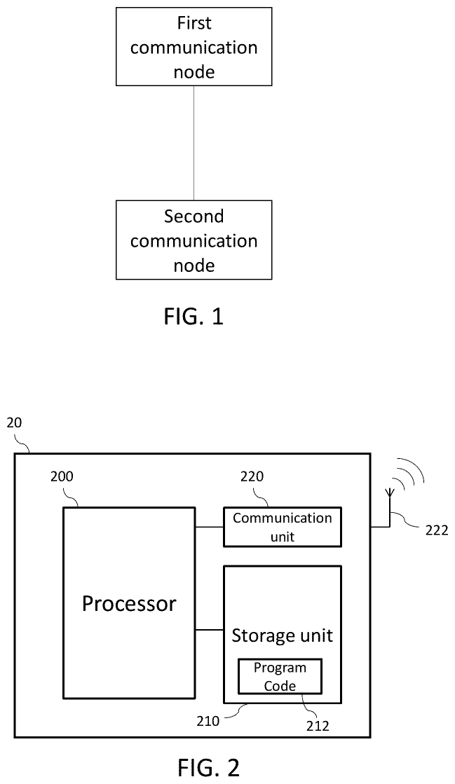

FIG. 1 shows a schematic diagram of a network (architecture) according to an embodiment of the present disclosure. The network (architecture) shown in FIG. 1 comprises a first communication node and a second communication node. The first communication node may be a UE, a WUR, . . . , etc. The second communication node may be a BS, a gNB, an eNB, a repeater, a relay and so on.

FIG. 2 relates to a schematic diagram of a wireless terminal 20 according to an embodiment of the present disclosure. The wireless terminal 20 may be a user equipment (UE), a mobile phone, a laptop, a tablet computer, an electronic book or a portable computer system and is not limited herein. The wireless terminal 20 may include a processor 200 such as a microprocessor or Application Specific Integrated Circuit (ASIC), a storage unit 210 and a communication unit 220. The storage unit 210 may be any data storage device that stores a program code 212, which is accessed and executed by the processor 200. Embodiments of the storage unit 210 include but are not limited to a subscriber identity module (SIM), read-only memory (ROM), flash memory, random-access memory (RAM), hard-disk, and optical data storage device. The communication unit 220 may a transceiver and is used to transmit and receive signals (e.g., messages or packets) according to processing results of the processor 200. In an embodiment, the communication unit 220 transmits and receives the signals via at least one antenna 222 shown in FIG. 2.

In an embodiment, the storage unit 210 and the program code 212 may be omitted and the processor 200 may include a storage unit with stored program code.

The processor 200 may implement any one of the steps in exemplified embodiments on the wireless terminal 20, e.g., by executing the program code 212.

The communication unit 220 may be a transceiver. The communication unit 220 may as an alternative or in addition be combining a transmitting unit and a receiving unit configured to transmit and to receive, respectively, signals to and from a wireless network node (e.g., a base station).

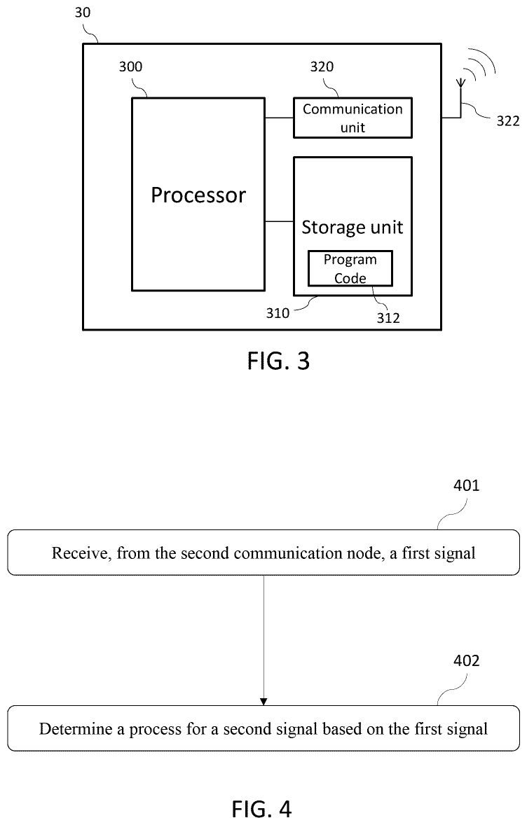

FIG. 3 relates to a schematic diagram of a wireless network node 30 according to an embodiment of the present disclosure. The wireless network node 30 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 30 may comprise (perform) at least one network function such as an access and mobility management function (AMF), a session management function (SMF), a user place function (UPF), a policy control function (PCF), an application function (AF), etc. The wireless network node 30 may include a processor 300 such as a microprocessor or ASIC, a storage unit 310 and a communication unit 320. The storage unit 310 may be any data storage device that stores a program code 312, which is accessed and executed by the processor 300. Examples of the storage unit 310 include but are not limited to a SIM, ROM, flash memory, RAM, hard-disk, and optical data storage device. The communication unit 320 may be a transceiver and is used to transmit and receive signals (e.g., messages or packets) according to processing results of the processor 300. In an example, the communication unit 320 transmits and receives the signals via at least one antenna 322 shown in FIG. 3.

In an embodiment, the storage unit 310 and the program code 312 may be omitted. The processor 300 may include a storage unit with stored program code.

The processor 300 may implement any steps described in exemplified embodiments on the wireless network node 30, e.g., via executing the program code 312.

The communication unit 320 may be a transceiver. The communication unit 320 may as an alternative or in addition be combining a transmitting unit and a receiving unit configured to transmit and to receive, respectively, signals to and from a wireless terminal (e.g., a user equipment or another wireless network node).

FIG. 4 shows a flowchart of a method according to an embodiment of the present disclosure. The method shown in FIG. 4 may be used in the first communication node shown in FIG. 1 and comprises the following steps:
Step 401: Receive, from the second communication node, a first signal.
Step 402: Determine a process for a second signal based on the first signal.

In FIG. 4, the first communication node receives a first signal from the second communication node and determines (and performs) a process for the second signal based on the first signal. Note that the determined process may be “not to process the second signal”.

In an embodiment, the first signal comprises at least one of at least one low power signal (e.g., LP-WUS or LP-SS), a paging channel (e.g. paging PDCCH, paging PDSCH, or paging occasion), a sequence, a reference signal, a downlink signal or a downlink channel.

In an embodiment, a modulation of the low power signal is OFK, ASK or FSK.

In an embodiment, the modulation of the low power signal may be OFDM based modulation.

In an embodiment, the low power signal is configured with a periodicity and/or at least one transmission in a time duration.

In an embodiment, the second signal comprises at least one of an SSB, a SIB, a paging signal, a PSS, an SSS, a physical random access channel, a msgA, a CSI-RS, a PDCCH, a paging channel, a PUCCH, a TRS, a sequence or a preamble.

In an embodiment, the first signal is configured for a first cell and the second signal is configured for a second cell.

In an embodiment, the first signal is configured for a first carrier and the second signal is configured for a second carrier.

In an embodiment, the first signal is configured for a first bandwidth part (BWP) and the second signal is configured for a second BWP.

In an embodiment, the first signal is configured for a first area and the second signal is configured for a second area. In this embodiment, the first/second area is a tracking area or a RAN area.

In an embodiment, the first signal is configured for a first RAT and the second signal is configured for a second RAT. For example, the first signal may be configured for one of LTE and NR and the second signal may be configured for another one of LTE and NR.

In an embodiment, a first frequency for the first signal is different from a second frequency for the second signal.

In an embodiment, the first frequency for the first signal is lower than the second frequency for the second signal.

In an embodiment, the first frequency for the first signal is predefined or indicated by a signaling. In some cases, the configuration for each signal has different or the same frequency.

In an embodiment, the first communication node determines the process for the second signal based on an indication carried by the first signal.

In an embodiment, the indication comprises one or more bits, one or more preambles, one or more sequences, or one or more CRC bits. For example, the indication may comprise synchronization sequences, PSS and SSS.

In an embodiment, the first communication node determines a reception of a third signal or a transmission of a fourth signal, wherein the third signal is a downlink signal and the fourth signal is an uplink signal. In other words, based on the first signal, the first communication node may determine to receive the third signal (comprised by the second signal) and/or to transmit the fourth signal.

In an embodiment, an occasion of the fourth signal is associated with the first signal.

In an embodiment, the first communication node determines the process for the second signal based at least one parameter associated with the first signal. For example, the parameter on which the determination of the process is based may be a metric (e.g., RSRP, RSRQ, RSSI, any metric associated with the signal strength or signal quality or a metric associated with a change in the signal strength or the signal quality of the first signal) of the first signal.

In an embodiment, the first communication node determines to perform the determined process if one of the at least one parameter is greater, smaller, not greater or not smaller than a threshold.

In an embodiment, the threshold is configured by the second communication node, a signaling, or downlink control information or predefined.

In an embodiment, the first communication node performs the process for the second signal if the parameter is greater, smaller, not greater or not smaller than the threshold in/for a period.

In an embodiment, the period is based on a timer, a signaling from the second communication node, a predefinition, or a downlink control information indication.

In an embodiment, the first communication node determines (and performs) the process for the second signal based on a predefined or a configured part of the first signal which is not received by the first communication node.

In an embodiment, the first communication node determines (and performs) the process for the second signal based on a predefined or a configured part of the first signal which is not present in the received first signal.

In an embodiment, the predefined or the configured part comprises at least one of at least a field, a sequence, a preamble or the N bits in the first signal, where N is a positive integer.

In an embodiment, the first communication node determines the process for the second signal based on the first signal and a fifth signal (e.g., a sequence, a preamble, or a reference signal) received from the second communication node.

In an embodiment, the first communication node performs the process within or after a time offset, a gap or a duration after receiving the first signal.

In an embodiment, the first communication node receives, from the second communication node, the first signal in a first frequency in response to a paging.

In an embodiment, the first communication node receives, from the second communication node, the first signal in the first frequency in response to a paging and one of a low power signal, a sequence, a preamble or an SSB or an DL signal.

In an embodiment, the first signal overlaps with the second signal in time domain and/or frequency domain.

In an embodiment, the first signal and the second signal are continuous/contiguous in time domain and/or frequency domain.

In an embodiment, the first communication node receives, from the second communication node, the first signal if at least one condition is met. For example, the at least one condition comprises at least one of:
at least one parameter associated with a low power signal, a reference signal, a sequence or a preamble stratifies at least one threshold condition,
a predefined/configured low power signal, reference signal, the sequence or the preamble is received, or
a reference signal, a sequence or a preamble of a low power signal is received.

In an embodiment, the UE does not receive the first signal under certain conditions. For example, the UE does not (need to) receive the first signal in at least one of the following conditions:
when/if the UE receives a corresponding indication from the BS (e.g., gNB);
the gNB indicates that the first signal (e.g., LP-WUS/LP-SSS) is not valid/configured in the connected mode and the UE is in the connected mode;
a signaling received from/via the BS (e.g., gNB) indicates that the UE does not (need to) receive/detect/monitor/decode the first signal (e.g., LP-WUS/LP-SSS);
the gNB indicates that in a time duration/in a period, the UE does not need to receive/detect/monitor/decode the first signal (e.g., LP-WUS/LP-SSS);
when/if the UE receives a signal from the BS:

For example, the signal is a msg4 (in a random access procedure). In this example, the UE receives the msg4 (successfully) from the BS and does not (need to) receive the first signal (e.g., LP-WUS/LP-SSS). As an alternative, the signal is the third signal (e.g., Paging/SSB).
when/if the UE send a signal, wherein the signal may comprise at least one of msg5 (in a random access procedure), UE capability report, PRACH, msgA, or ACK/NACK.

For example, after UE sends the msg5 (in a random access procedure), after UE is in connected mode, after UE sends the capability report, after the UE sends the PRACH/msgA, or after UE feedbacks ACK/NACK, the UE does not (need to) receive the first signal (e.g., LP-WUS/LP-SS) or whether the UE receives the first signal is up to the UE (implementation).

In an embodiment, the first communication node determines not to receive the third signal comprised by the second signal if at least one condition is met. In this embodiment, the at least one condition comprises at least one of:
at least one parameter associated with the first signal stratifies at least one threshold condition,
the first signal is received,
the first communication node is in a connected state,
downlink control information for a connected mode is received, or
an indication is received via the first signal, a SIB, a MAC CE or an RRC signaling/parameter.

For example, if the (metric) parameter for the LP-SS/reference signal/sequence/preamble is less or larger than a threshold value, the UE does not receive the third signal (e.g., SSB).

For example, if the LP-WUS/LP-SS/reference signal/sequence/preamble is detected/monitored/received/configured/decoded, the UE does not receive the third signal (e.g., SSB).

For example, the first communication is in connected mode. In the connected mode, the UE receives the first signal and does not receive the third signal.

For example, according to an indication/signaling from the BS (e.g., gNB), the UE receives the first signal and does not receive/detect/monitor/decode the third signal (e.g., SSB). In an embodiment, the indication from the BS may be an RRC signaling, a DCI signaling, a SIB signaling, or a Mac signaling. In an embodiment, the signaling may be an activation signaling/deactivation signaling.

For example, according to a time duration, the UE receives the first signal and does not receive/detect/monitor/decode the third signal in the time duration. That is, within the time duration after receiving the first signal, the UE does not receive/detect/monitor/decode the third signal.

For example, according to a timer, the UE receives the first signal and does not receive/detect/monitor/decode the third signal (e.g., SSB). In an embodiment, the timer is triggered/activated/started in response to the reception of the first signal. Before the timer expires, the UE does not receive the third signal.

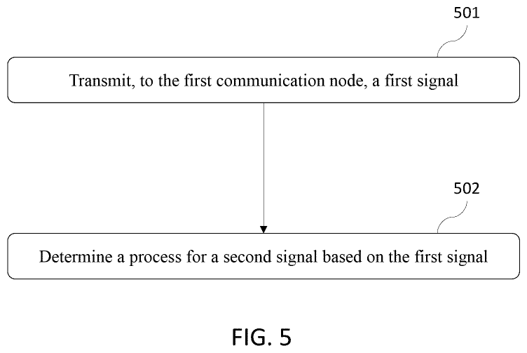

FIG. 5 shows a flowchart of a method according to an embodiment of the present disclosure. The method shown in FIG. 5 may be used in the second communication node in FIG. 1 and comprises the following steps:
Step 501: Transmit, to the first communication node, a first signal.
Step 502: Determine a process for a second signal based on the first signal.

In FIG. 5, the second communication node transmits a first signal to the first communication node and determines (and performs) the process for a second signal based on the first signal.

In an embodiment, the first signal comprises at least one of at least one low power signal (e.g., LP-WUS or LP-SS), a paging channel (e.g. paging PDCCH, paging PDSCH, or paging occasion), a sequence, a reference signal, a downlink signal or a downlink channel.

In an embodiment, a modulation of the low power signal is OFK, ASK or FSK.

In an embodiment, the modulation of the low power signal may be OFDM based modulation.

In an embodiment, the low power signal is configured with a periodicity and/or at least one transmission in a time duration.

In an embodiment, the second signal comprises at least one of an SSB, a SIB, a paging signal, a PSS, an SSS, a physical random access channel, a msgA, a CSI-RS, a PDCCH, a paging channel, a PUCCH, a TRS, a sequence or a preamble.

In an embodiment, the first signal is configured for a first cell and the second signal is configured for a second cell.

In an embodiment, the first signal is configured for a first carrier and the second signal is configured for a second carrier.

In an embodiment, the first signal is configured for a first bandwidth part (BWP) and the second signal is configured for a second BWP.

In an embodiment, the first signal is configured for a first area and the second signal is configured for a second area. In this embodiment, the first/second area is a tracking area or a RAN area.

In an embodiment, the first signal is configured for a first RAT and the second signal is configured for a second RAT. For example, the first signal may be configured for one of LTE and NR and the second signal may be configured for another one of LTE and NR.

In an embodiment, a first frequency for the first signal is different from a second frequency for the second signal.

In an embodiment, the first frequency for the first signal is lower than the second frequency for the second signal.

In an embodiment, the first frequency for the first signal is predefined or indicated by a signaling. In some cases, the configuration for each signal has different or the same frequency.

In an embodiment, the first signal carries an indication of the process.

In an embodiment, the indication comprises one or more bits, one or more preambles, one or more sequences, or one or more CRC bits. For example, the indication may comprise synchronization sequences, PSS and SSS.

In an embodiment, the second communication node may determine a transmission of a third signal or a reception/transmission of a fourth signal, wherein the third signal is a downlink signal and the fourth signal is an uplink signal. That is, based on the first signal, the second communication node may determine to transmit the third signal and/or to receive the fourth signal.

In an embodiment, an occasion of the fourth signal is associated with the first signal.

In an embodiment, the second communication node determines the process for the second signal based on the first signal and a fifth signal transmitted to the first communication node.

In an embodiment, the second communication node performs the process within or after a time offset, a gap or a duration after transmitting the first signal.

In an embodiment, the second communication node transmits, to the first communication node, the first signal in a first frequency in response to a paging (transmitted to the first communication node).

In an embodiment, the second communication node transmits, to the first communication node, the first signal in a first frequency in response to a paging and one of a low power signal, a sequence, a preamble, an SSB or a downlink signal.

In an embodiment, the first signal overlaps with the second signal in time domain and/or frequency domain.

In an embodiment, the first signal and the second signal are continuous/contiguous in time domain and/or frequency domain.

In an embodiment, the second communication node transmits, to the first communication node, the first signal if at least one condition is met. For instance, the at least one condition comprises at least one of:
at least one parameter associated with a low power signal, a reference signal, a sequence or a preamble stratifies at least one threshold condition,
a predefined/configured low power signal, reference signal, the sequence or the preamble is transmitted,
a reference signal, a sequence or a preamble of a low power signal is transmitted, or
an RRC configuration or a SIB configuration is transmitted.

In an embodiment, the second communication node determines not to transmit a third signal comprised by the second signal if at least one condition is met. In this embodiment, the at least one condition comprises at least one of:
the first signal is transmitted,
the first communication node is in a connected state,
downlink control information for a connected mode is transmitted,
an indication is transmitted via the first signal, a SIB, a MAC CE or an RRC parameter/signaling.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method for use in a first communication node, the method comprising:
receiving, from a second communication node, a first signal, and determining a process for a second signal based on the first signal.

2. The wireless communication method of claim 1, wherein the first signal comprises at least one of at least one low power signal, a paging channel, a sequence, a reference signal, a downlink signal or a downlink channel,
wherein:
a modulation of the low power signal is On-Off Keying, Amplitude Shift Keying or Frequency-Shift Keying,
the low power signal is configured with a periodicity and/or at least one transmission in a time duration,
the second signal comprises at least one of an SS/physical broadcast channel block (SSB), a system information block, a paging signal, a Primary Synchronization Sequence (PSS), a Secondary Synchronization Sequence (SSS), a physical random access channel, a message A (msgA), a channel state information reference signal, a physical downlink control channel, a paging channel, a physical uplink control channel, a tracking reference signal, a sequence or a preamble.

3. The wireless communication method of claim 1,
wherein the first signal is configured for a first cell and the second signal is configured for a second cell, or
wherein the first signal is configured for a first carrier and the second signal is configured for a second carrier, or wherein the first signal is configured for a first bandwidth part (BWP) and the second signal is configured for a second BWP, or
wherein the first signal is configured for a first area and the second signal is configured for a second area, or
wherein the first signal is configured for a first radio access technology (RAT) and the second signal is configured for a second RAT.

4. The wireless communication method of claim 1, wherein a first frequency for the first signal is different from a second frequency for the second signal, or wherein the first frequency for the first signal is lower than the second frequency for the second signal,
wherein the first frequency for the first signal is predefined or indicated by a signaling.

5. The wireless communication method of claim 1, wherein determining the process for the second signal based on the first signal comprises:
determining the process for the second signal based on an indication carried by the first signal, wherein:
the indication comprises one or more bits, one or more preambles, one or more sequences, or one or more cyclic redundance check (CRC) bits.

6. The wireless communication method of claim 5, wherein
determining the process for the second signal based on the first signal comprises: determining a reception of a third signal or a transmission of a fourth signal, wherein the third signal is a downlink signal and the fourth signal is an uplink signal, wherein an occasion of the fourth signal is associated with the first signal.

7. The wireless communication method of claim 1, wherein determining the process for the second signal based on the first signal comprises:
determining the process for the second signal based on at least one parameter associated with the first signal.

8. The wireless communication method of claim 7, wherein:
determining the process for the second signal based on the first signal comprises:
performing the process for the second signal if one of the at least one parameter is greater, smaller, not greater or not smaller than a threshold,
the threshold is configured by the second communication node, a signaling, or downlink control information or predefined, and
performing the process for the second signal if the parameter is greater, smaller, not greater or not smaller than the threshold comprises: performing the process for the second signal if the parameter is greater, smaller, not greater or not smaller than the threshold in a period, wherein the period is based on a timer, a signaling from the second communication node, a predefinition, or a downlink control information indication.

9. The wireless communication method of claim 7, wherein the at least one parameter comprises at least one of a reference signal received power, a reference signal received quality, a received signal strength indicator, a metric associated with a signal strength or a signal quality of the first signal, or a metric associated with a change in the signal strength or the signal quality of the first signal.

10. The wireless communication method of claim 1,
wherein determining the process for the second signal based on the first signal comprises: determining the process for the second signal based on a predefined or a configured part of the first signal which is not received by the first communication node, or determining the process for the second signal based on a predefined or a configured part of the first signal which is not present in the received first signal, wherein the predefined or the configured part comprises at least one of at least a field, a sequence, a preamble or the N bits in the first signal, where N is a positive integer, or
wherein determining the process for the second signal based on the first signal comprises: determining the process for the second signal based on the first signal and a fifth signal received from the second communication node.

11. The wireless communication method of claim 1, wherein the process is performed within or after a time offset, a gap or a duration after receiving the first signal.

12. The wireless communication method of claim 1, wherein receiving, from the second communication node, the first signal comprises:
receiving, from the second communication node, the first signal in a first frequency in response to a paging, or
receiving, from the second communication node, the first signal in the first frequency in response to a paging and a low power signal, a sequence, a preamble or an SSB or an DL signal.

13. The wireless communication method of claim 1, wherein the first signal overlaps with the second signal in time domain and/or frequency domain,
wherein the first signal and the second signal are continuous in time domain and/or frequency domain.

14. The wireless communication method of claim 1,
wherein receiving, from the second communication node, the first signal comprises: receiving, from the second communication node, the first signal if at least one condition is met.

15. The wireless communication method of claim 14, wherein the at least one condition comprises at least one of:
at least one parameter associated with a low power signal, a reference signal, a sequence or a preamble stratifies at least one threshold condition,
a predefined/configured low power signal, reference signal, the sequence or the preamble is received,
a reference signal, a sequence or a preamble of a low power signal is received; or
an RRC configuration or a SIB configuration is received.

16. The wireless communication method of claim 1, wherein determining the process for the second signal based on the first signal comprises: determining not to receive a third signal comprised by the second signal if at least one condition is met.

17. The wireless communication method of claim 16, wherein the at least one condition comprises at least one of:
at least one parameter associated with the first signal satisfies at least one threshold condition,
the first signal is received,
the first communication node is in a connected state,
downlink control information for a connected mode is received, or
an indication is received via the first signal, a system information block, a media access control control element or a radio resource control parameter.

18. A wireless communication method for use in a second communication node, the method comprising:
transmitting, to a first communication node, a first signal, and
determining a process for a second signal based on the first signal.

19. A first communication node, comprising:
a communication unit, configured to receive, from a second communication node, a first signal, and
at least one processor, configured to determine a process for a second signal based on the first signal.

20. A second communication node, comprising:
a communication unit, configured to transmit, to a first communication node, a first signal, and
at least one processor, configured to determine a process for a second signal based on the first signal.
